(19) United States
(12) Patent Application Publication
(10) Pub. No.: US 2015/0110168 A1
(43) Pub. Date: Apr. 23, 2015

(54) VIDEO DATA TRANSMISSION METHOD AND APPARATUS

(71) Applicant: HUAWEI TECHNOLOGIES CO., LTD., Shenzhen (CN)

(72) Inventors: Chen CHI, Beijing (CN); Wei Bai, Shenzhen (CN)

(73) Assignee: HUAWEI TECHNOLOGIES CO., LTD., Shenzhen (CN)

(21) Appl. No.: 14/581,231

(22) Filed: Dec. 23, 2014

Related U.S. Application Data
(63) Continuation of application No. PCT/CN2012/077932, filed on Jun. 29, 2012.

(51) Int. Cl. H04L 29/06

(52) U.S. Cl. CPC H04L 65/607; H04L 65/608
USPC 375/240.01

(57) ABSTRACT

The present invention relates to a video data coding method and apparatus, where the method includes: obtaining a video file; compressing the obtained video file into a video stream; adding indication information before data of each group of pictures among the data of the multiple groups of pictures in the video stream, where a user terminal or a base station learns, based on the indication information, a priority and a size of each data frame in the data of the group of pictures behind the indication information. In the transmission method provided by an embodiment of the present invention, a base station can perform differentiated transmission of the video stream based on the obtained priority information and size information, and a handheld terminal can also request, the base station to perform differentiated transmission of video data, thereby improving user experience of the terminal.

### CROSS REFERENCE

This application is a continuation of International Application No. PCT/CN2012/077932, filed on Jun. 29, 2012, which is hereby incorporated by reference in its entirety.

### TECHNICAL FIELD

The present invention relates to the field of radio communications, and in particular, to a video data transmission method and an apparatus.

### BACKGROUND

Scalable video coding (SVC) is one of existing video data coding mechanisms, and is characterized by capability of coding an original video into a video stream that is scalable/can be layered. The SVC video stream has one basic layer and several enhancement layers. A receiving terminal, when a channel bandwidth is limited, needs to receive only the basic layer to decode and restore a video file that meets basic quality. When the channel bandwidth is sufficient, it may be considered to receive the enhancement layers to decode and obtain a high quality video file. The SVC video stream is suitable to be applied in an LTE system, so that the LTE system can better transmit video data. The LTE system performs differentiated transmission of the SVC video stream according to different priorities of the basic layer and the enhancement layers, to improve experience of a user terminal.

In the prior art, this technology needs to perform a DPI inspection on each data packet, thereby causing intensive calculation and delay. For video data that adopts a proprietary protocol and DRM protection, a channel cannot be inspected through a DPI technology.

### SUMMARY

Embodiments of the present invention provide a data transmission method, so as to enable a base station or a mobile terminal to use a simple manner to obtain priority and size information of a video stream in video transmission data from the obtained video transmission data.

In one aspect, a video data coding method is provided, where the method includes:

obtaining video information;

coding the video information into a video stream, where the video stream includes data of a group of pictures; and

setting indication information for the data of the group of pictures, and putting the indication information before the corresponding data of the group of pictures, where the indication information includes a priority and a data amount of each data frame in the corresponding data of the group of pictures.

In one aspect, a video data transmission method is provided, where the method includes:

obtaining a video stream;

performing a deep packet inspection on the video stream, and obtaining data of a group of pictures and indication information corresponding to the data of the group of pictures;

obtaining a priority of each data frame in the data of the group of pictures from the indication information; and

sending the data frame in the data of the group of pictures of the video stream according to an order of the priority.

In one aspect, the present invention provides a video data transmission method, where the method includes:

receiving a video stream through a downlink channel;

performing a deep inspection on the received video stream, and obtaining indication information;

learning a data amount and a priority of each video data packet in the video stream based on the obtained indication information; and

sending a resource request to a base station according to a current downlink channel resource and the data amount of the video data packet.

In one aspect, a video coding apparatus is provided, where the apparatus includes:

an obtaining unit, configured to obtain video information;

a coding unit, configured to code the obtained video information into a video stream, where the video stream includes data of multiple groups of pictures; and

an inserting unit, configured to set indication information for the data of the group of pictures, and put the indication information before the corresponding data of the group of pictures, where the indication information includes a priority and a data amount of each data frame in the corresponding data of the group of pictures.

In one aspect, a base station is provided, where the base station includes:

a video stream obtaining unit, configured to obtain a video stream through a network;

an indication information obtaining unit, configured to perform a deep packet inspection on the video stream, and obtain data of a group of pictures and indication information corresponding to the data of the group of pictures;

a priority obtaining unit, configured to obtain a priority of each data frame in the data of the group of pictures from the indication information; and

a data frame sending unit, configured to send the data frame in the data of the group of pictures of the video stream according to an order of the priority.

In one aspect, a handheld terminal is provided, where the terminal includes:

a receiving unit, configured to receive a video stream through a downlink channel;

an inspection unit, configured to perform a deep inspection on the received video stream and obtain indication information;

an obtaining unit, configured to learn a size and a priority of each video data packet in the video stream based on the obtained indication information; and

a request unit, configured to send a resource request to a base station according to a current downlink channel resource and the size of the video data packet.

Embodiments of the present invention provide a video data transmission method, where auxiliary indication information in a video stream is detected, and priority information and size information of a subsequent stream are obtained, so that a base station can perform differentiated transmission of the video stream based on the obtained priority information and size information, and a handheld terminal can also request, based on the indication information in the received video stream in combination with a current channel resource status, the base station to perform the differentiated transmission of video data, without the need to perform a full DPI inspection on a data packet to obtain information such as a quality layer number, a priority number, and a time layer number, thereby reducing inspection complexity and improving user experience of the terminal.

### BRIEF DESCRIPTION OF DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is an architectural diagram of an application system for a video coding method according to an embodiment of the present invention;

FIG. 2 is a flowchart of a video coding method according to an embodiment of the present invention;

FIG. 3 is a flowchart of another embodiment of a video coding method according to an embodiment of the present invention;

FIG. 4 is a status reference diagram of a video coding method according to an embodiment of the present invention;

FIG. 5 is a flowchart of another embodiment of a video data transmission method according to an embodiment of the present invention;

FIG. 6 is a flowchart of another embodiment of a video data transmission method according to an embodiment of the present invention;

FIG. 7 is a schematic structural diagram of a video coding apparatus according to an embodiment of the present invention;

FIG. 8 is a schematic structural diagram of a video data transmission apparatus according to an embodiment of the present invention; and

FIG. 9 is a schematic structural diagram of a video data transmission apparatus according to an embodiment of the present invention.

### DESCRIPTION OF EMBODIMENTS

To make the objectives, technical solutions, and advantages of the present invention more comprehensible, the following further describes the present invention in detail with reference to the accompanying drawings. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

Embodiments of the present invention provide a video data transmission method, where auxiliary indication information in a video stream is detected, and priority information and size information of a subsequent stream are obtained, so that a base station can perform differentiated transmission of the video stream based on the obtained priority information and size information, and a handheld terminal can also request, based on the indication information in the received video stream in combination with a current channel resource status, the base station to perform the differentiated transmission of video data, thereby improving user experience of the terminal.

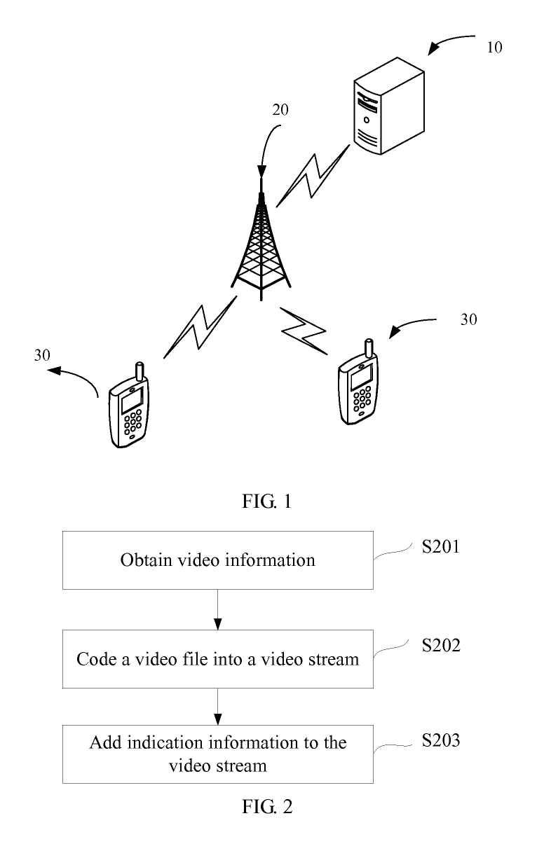

FIG. 1 is a system application architecture diagram of a video transmission method provided by an embodiment of the present invention. As shown in FIG. 1, a system architecture, to which the video transmission method provided by the embodiment of the present invention is applied, includes a video file server sever10, an evolved NodeB eNB20, and several handheld terminals UE30 that access the evolved NodeB 20 through a downlink channel.

The server 10 may include, but not limited to, a network server, and the network server can obtain a video file shot by a user, compress and code the video file, and transmit the coded video file to the evolved NodeB 20; then the evolved NodeB 20 transmits video data to the handheld terminal UE30 through the downlink channel, the handheld terminal 30 decodes the coded video file, and the video file is played on the handheld terminal 30. In the embodiment of the present invention, the network server codes the video file uploaded by the user, and adds indication information to a video stream during coding; the evolved NodeB 20 inspects the video data, and after detecting the indication information, performs differentiated transmission of the video data to the channel based on the priority and/or data packet size information in the indication information; after receiving the indication information, the user terminal 30 can learn an order of the priority and a data packet size of the subsequent video stream, refer to a current channel resource status, and send a differentiated resource request to the base station, improving experience of watching the video file on the user terminal.

FIG. 2 is a flowchart of a video coding method provided by an embodiment of the present invention, and as shown in FIG. 2, the method includes the following steps.

Step S201: Obtain video information.

Specifically, the video information obtained by a server may include, but not limited to, a video file obtained by a user in a manner such as uploading through a camera, downloading from a network, and video capture.

Step S202: Code the obtained video file into a video stream, where the video stream includes data of multiple groups of pictures.

Specifically, a coding apparatus, for example, an encoder, in the server, codes the video file according to a resolution, coding format, coding standard, frame rate, and bit rate that are set, and obtains data of multiple groups of pictures (GOP). The coding standard is, for example, the SVC standard in H.264, from which scalable video streams are obtained.

Step S203: Set indication information for the data of the group of pictures, and put the indication information before the corresponding data of the group of pictures, where the indication information is used to indicate a priority and a data amount of each data frame in the corresponding data of the group of pictures.

Specifically, the indication information is added to the coded data of group of pictures, to indicate priorities and sizes of different frames in data of the subsequent group of pictures. In an actual application, one indication information packet may be set for data of each group of pictures data, or the data of the multiple groups of pictures may share one indication information packet.

A space occupied by the indication information is far less than a data packet size. A representation of the indication information may be agreed according to a terminal, a base station, and a server. For example, 00000 indicates that a priority is 1, and 10010 indicates that a priority is 2. The standard for the data packet size is generally that, each IP packet occupies 1.5K bytes; if one subsequent data packet occupies 15K bytes, the data packet size may be displayed as 001010. A field indicating a data packet size may be put behind a field indicating a priority.

In an actual application, indication information may not directly indicate a priority, but a layered information field or a frame coding type field is used to indicate priorities of different data frames in the data of the group of pictures.

After obtaining the video stream, the user terminal or the evolved NodeB can learn the priority and size of a data packet in data of a subsequent group of pictures by obtaining the indication information in a video stream data header, and can perform differentiated transmission of the video data by referring to a current channel status and according to the priority and the data packet size. For example, when channel resources are tight, only a data packet with a higher priority is transmitted, so that a user can obtain the basic video data to meet a basic playing requirement. When the channel resources are sufficient, a data packet with a lower priority is delivered, so that the user can obtain a video playing effect with high quality and definition.

In the video coding method provided by the foregoing embodiment, the indication information is added to the video stream, so that the base station can identify a size and priority of the IP packet and perform the differentiated transmission of the IP packet for the obtained priority without the need to perform a deep inspection on a real application of a data packet in the IP packet at an application layer, thereby reducing complexity and transmission delay, and improving the video watching effect at the user end.

The foregoing embodiment uses the video coding as an example, however, persons skilled in the art should understand that, for audio data coding with a layered coding architecture, the technology provided by the present invention may also be adopted, that is, indication information is used to indicate sizes and an order of priorities of data frames in subsequent audio data, so that a base station can obtain the sizes and the order of priorities of the data frames in the subsequent audio data based on the indication information in an indication information packet, and perform differentiated transmission.

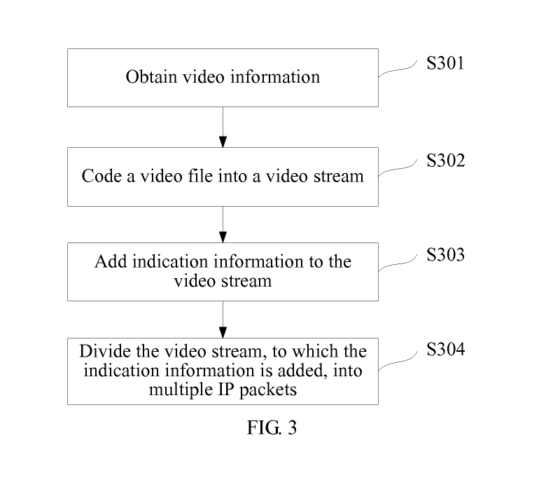

FIG. 3 is a flowchart of another embodiment of a video coding method provided by an embodiment of the present invention, and as shown in the figure, the method includes the following steps.

Step S301: Obtain video information.

Specifically, the video information obtained by a server may include, but not limited to, a video file obtained by a user in a manner such as uploading through a camera, downloading from a network, and video capture.

Step S302: Code the obtained video file into a video stream, where the video stream includes data of multiple groups of pictures.

Specifically, a coding apparatus, for example, an encoder, in the server, codes the video file according to a resolution, coding format, coding standard, frame rate, and bit rate that are set, and obtains data of multiple groups of pictures (GOP). The coding standard is, for example, the SVC standard in H.264, from which scalable video streams are obtained.

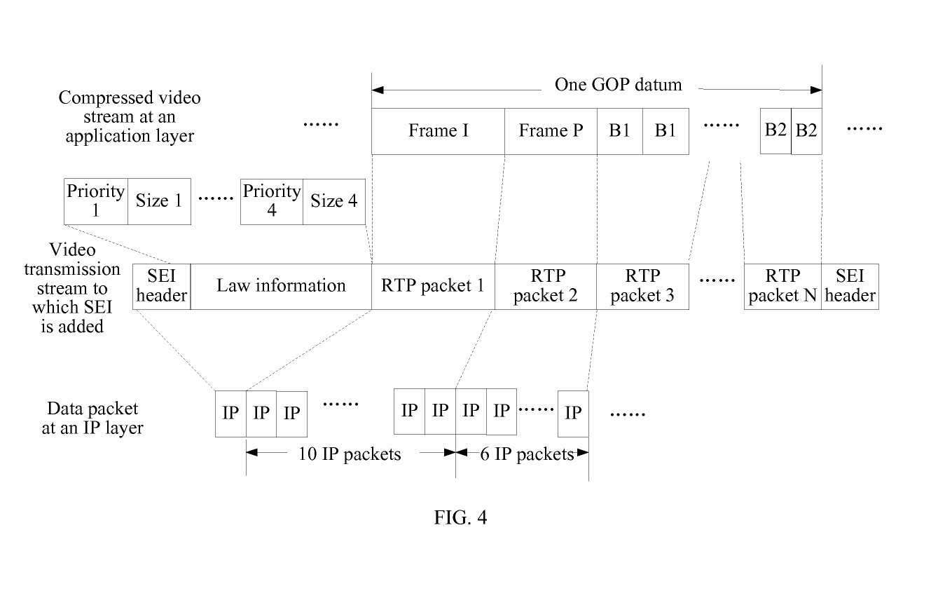

FIG. 4 is a video coding process diagram of a video coding method provided by an embodiment of the present invention, where the embodiment uses transmission of an H.264 SVC video in LTE as an example. Assume that a coding parameter GOP is 8, and a time layer is 4. Flow control is adopted in an encoder for controlling so that a data packet size and a priority at each layer in an obtained coded stream are shown in Table 1, where a coding law of one GOP datum is IPB1B1B2B2B2B2B2, which is repeated, and each type of data frame may act as a real-time transmission protocol packet (RTP), as shown in FIG. 4.

TABLE 1

| Time layer | Size (byte) | Priority |
|---|---|---|
| 0 (corresponding to a frame I) | 15k | 1 |
| 1 (corresponding to a frame P) | 9k | 2 |
| 2 (corresponding to a frame B1) | 3k | 3 |
| 3 (corresponding to a frame B2) | 1.5k | 4 |

Step S303: Set indication information for the data of the group of pictures, and put the indication information before the corresponding data of the group of pictures, where the indication information includes a priority and a data amount of each data frame in the corresponding data of the group of pictures.

Specifically, the indication information is added to the coded data of the group of pictures, to indicate priorities and sizes of different frames in data of the subsequent group of pictures. In a format of an indication message shown in Table 2, the priorities and sizes may be arranged sequentially, or several data amount fields identifying the sizes may be arranged after several priority fields.

TABLE 2

| | | | | | | | |
|---|---|---|---|---|---|---|---|
| SEI packet header | Priority 1 | Size 1 | Priority 2 | Size 2 | . . . | Priority M | Size M |

Refer to Table 3 in combination with the size and the priority of each data frame in Table 1.

TABLE 3

| | | | | | | | | |
|---|---|---|---|---|---|---|---|---|
| SEI packet header | 1 | 15 k | 2 | 9 k | 3 | 6 k | 4 | 6 k |

The indication information shown in Table 3 may be added before a GOP datum, that is, the indication information is added before an RTP packet 1 in the group of RTP packets corresponding to IPB1B1B2B2B2B2B2, to indicate the size and the order of the priority of each RTP packet in a group of RTP packets. A specific identification rule may be determined according to an actual agreement, and reference may be made to description in the foregoing embodiment.

The foregoing embodiment uses the example of setting one indication information packet for data of one group of pictures. Actually, if the data frame sizes and the data frame priorities of data of multiple groups of pictures are the same or similar, one same indication information packet may be shared, and one or more law indication fields may be added to the indication information packet to indicate a law of change of the data frame priorities and the data frame sizes in data of the subsequent group of pictures. For example, a special field bit is used to indicate that the data frame sizes and priorities in data of the subsequent group of pictures are the same as those in data of the first group of pictures.

If multiple law indication fields are added, the laws of the data frames in data of the subsequent multiple groups of pictures can be separately identified.

In an actual application, indication information may not directly indicate a priority, but a layered information field or a frame coding type field is used to indicate priorities of different data frames in data of the group of pictures.

Step S304: Divide the video stream, to which the indication information is added, into multiple IP packets.

Specifically, assume that an IP packet size is 1.5K bytes, and in information about data packets behind an indication information packet, it may be determined, according to a law, that: a priority of 10 IP packets is 1, a priority of 6 IP packets is 2, a priority of 4 IP packets is 3, and a priority of 4 IP packets is 4. By comparison, one indication information packet occupies the number of bytes of only one IP packet or fewer.

Through the foregoing embodiment, a base station can learn a priority and size of each frame in a subsequent group of pictures after receiving a first indication information packet. Disordered IP packets are sorted again according to sequence numbers in RTP packet headers, and differentiated transmission to a channel is performed on different IP packets.

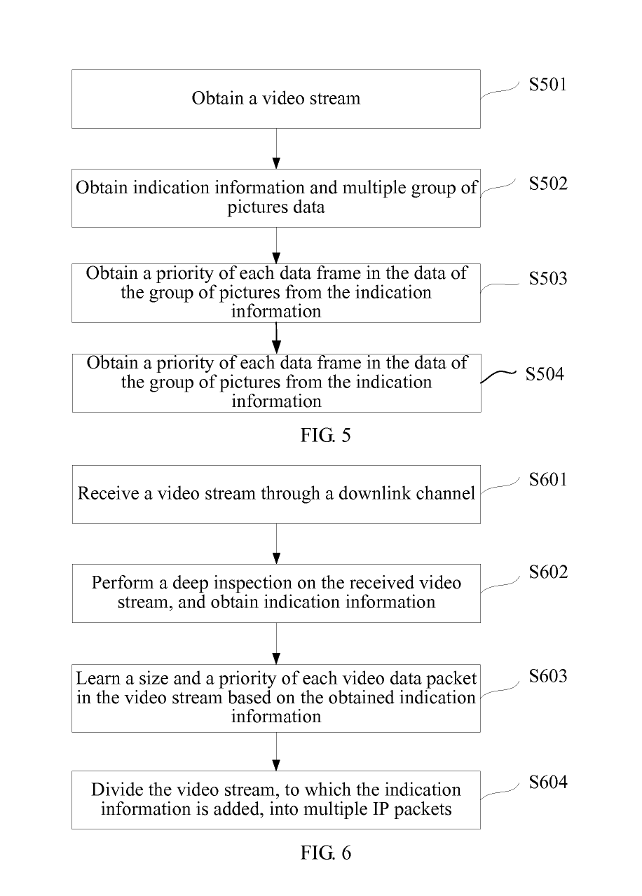

FIG. 5 is a flowchart of an embodiment of a video data transmission method provided by an embodiment of the present invention, and as shown in the figure, the method includes the following steps.

Step S501: Obtain a video stream.

Specifically, a base station obtains, through a network, the coded video stream, for example, H.2264 SVC coded video data, provided by a video file providing network.

Step S502: Perform a deep packet inspection on the obtained video stream, and obtain data of a group of pictures and indication information corresponding to the data of the group of pictures.

Specifically, the base station inspects the obtained video stream that includes multiple IP packets, and sorts the disordered IP packets again. Reference information for sorting the IP packets includes, but not limited to, sequence numbers in RTP packet headers.

Indication information SEI is detected in the received video stream, and priority and data packet size information included in the indication information is identified.

Step S503: Obtain the priority of each data frame in the data of the group of pictures from the indication information.

If the indication information indicates data of multiple groups of pictures at the same time, a law of change of data of the multiple groups of pictures after data of the first group of pictures needs be obtained from the indication information. For example, all data frame priorities and data frame sizes in data of the subsequent group of pictures are the same as those in the data of the first group of pictures.

In an actual application, if indication information adopts a layered information field or a frame coding type field to represent priorities of different data frames in data of the group of pictures, a base station may map the layered information field or the frame coding type field as priority information.

Step S504: Send the data frame in the data of the group of pictures of the video stream according to an order of the priority.

Specifically, after detecting an indication information packet in the video stream, the base station reads the IP packet size and priority information from the indication information packet, and sends the subsequent multiple data packets in a channel according to the order of the priorities. For example, it is determined whether a current channel resource is sufficient by referring to the sizes of the subsequent IP packets in the indication information; if the channel resource is sufficient, the subsequent data packets may be transmitted sequentially without considering the order of the priorities. If the channel resource is insufficient, selectively differentiated transmission of the subsequent IP packets is performed based on a priority indication in the indication information, so that a user terminal can still obtain a video file that meets a basic playing requirement when the channel resource is insufficient.

Through the foregoing embodiment, the base station may obtain the priority and size information of the data packet in the subsequent video stream based on the indication information in the video stream, and perform the differentiated transmission of the data packets based on the different priorities and a channel resource status, thereby preventing the deep packet inspection from being performed on the data of each frame, reducing an inspection frequency, and improving transmission efficiency.

The foregoing embodiment uses the video coding as an example, however, persons skilled in the art should understand that, for audio data coding with a layered coding architecture, the technology provided by the present invention may also be adopted, that is, indication information is used to indicate sizes and an order of priorities of data frames in subsequent audio data, so that a base station can obtain the sizes and the order of priorities of the data frames in the subsequent audio data based on the indication information in an indication information packet, and perform differentiated transmission.

FIG. 6 is a flowchart of a video data transmission method provided by an embodiment of the present invention, and as shown in FIG. 6, the method includes the following steps.

Step S601: Receive a video stream through a downlink channel.

Specifically, a handheld terminal UE receives, in a channel, a video stream below a base station, where the video stream is multiple IP packets, and sorts the IP packets based on sequence numbers in RTP packets after receiving the multiple IP packets.

Step S602: Perform a deep inspection on the received video stream and obtain indication information.

Specifically, the indication information is detected based on a packet header of SEI indication information. Among the multiple data packets, the multiple data packets of a same group of pictures include one indication information packet.

Step S603: Learn a size and a priority of each video data packet in the video stream based on the obtained indication information.

Specifically, the indication information packet includes the priority and size information of multiple RTP data packets. For example, as shown in FIG. 4, the following can be learned from the indication information packet: there are 10 IP packets with the priority being 1 and 6 IP packets with the priority being 2, and correspondingly, the priority of a frame I is 1 and the priority of a frame P is 2. The deep inspection needs to be performed for only once to learn priorities of the data packets in multiple data frames. This is different from an SEI packet indication method in the prior art, where specific priority information of only one certain frame is provided and a deep inspection needs to be performed on each frame.

In an actual application, if indication information adopts a layered information field or a frame coding type field to represent priorities of different data frames in data of a group of pictures, the UE may map the layered information field or the frame coding type field as priority information.

Step S604: Send a resource request to the base station according to a current downlink channel resource and the size and priority of the video data packet.

Specifically, the handheld terminal UE can determine whether the downlink channel resource is sufficient according to the learned data packet size; if the downlink channel resource is sufficient, the handheld terminal UE may adopt no flow control measure; if the downlink channel resource is insufficient, the handheld terminal UE may send a resource request to the base station based on a priority status in the indication information.

Additionally, a channel resource may be requested from the base station based on the size and priority of a subsequent video data packet obtained from the indication information packet. For example, if the channel resource is insufficient, transmission of video data with a higher priority through the channel occupying a small bandwidth may be requested; if the channel resource is sufficient, a resource difference does not need to be considered for the request.

Through the foregoing embodiment, the handheld terminal can learn the priorities and sizes of the different data packets in a subsequent video stream based on the indication information in the obtained video stream, determine whether the current channel resource is sufficient based on the sizes of the data packets, and request the data from the base station according to the priorities when the channel resource is insufficient, preventing the deep inspection from being performed frequently on one data packet and reducing data transmission delay.

The foregoing embodiment uses video coding as an example, however, persons skilled in the art should understand that, for audio data coding with a layered coding architecture, the technology provided by the present invention can also be adopted, that is, indication information is used to indicate sizes and an order of priorities of data frames in subsequent audio data, so that a mobile phone can obtain the sizes and the order of priorities of the data frames in the subsequent audio data based on the indication information in an indication information packet, and perform a differentiated resource request.

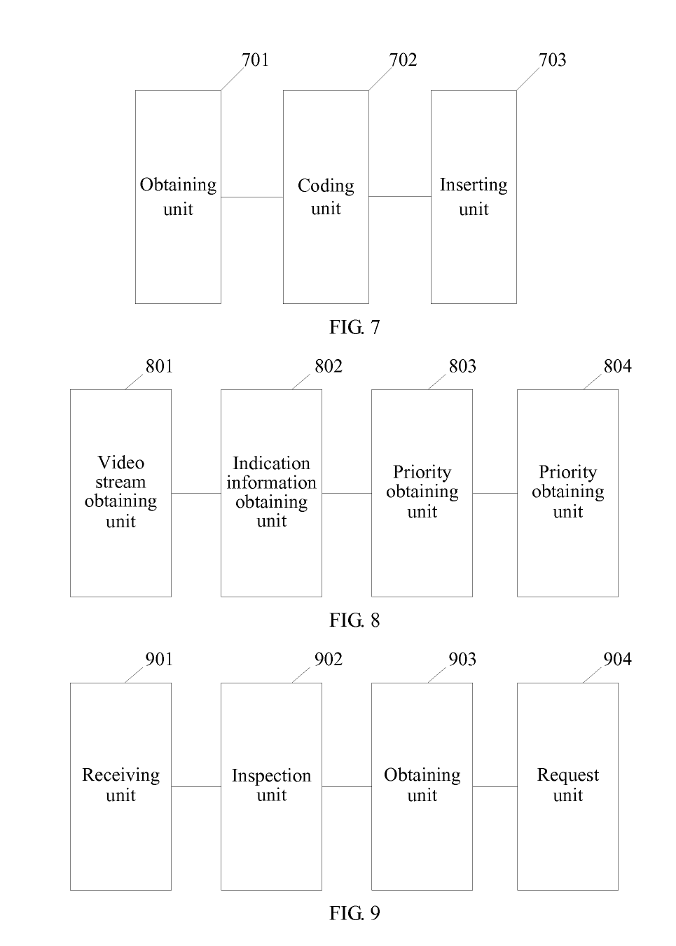

FIG. 7 is a schematic structural diagram of a video coding apparatus provided by an embodiment of the present invention, where the apparatus may specifically be an encoder. As shown in the figure, the apparatus includes:

an obtaining unit 701, configured to obtain video information and send the obtained video information to a coding unit 702;

the coding unit 702, configured to receive the video information obtained by the obtaining unit 701, code the video information into a video stream, and send the video stream to an inserting unit 703, where the video stream includes data of multiple groups of pictures; and

the inserting unit 703, configured to receive the video stream sent by 702 the coding unit, set indication information for the data of the group of pictures in the video stream, and put the indication information before data of the corresponding group of pictures, where the indication information is used to indicate a priority and a data amount of each data frame in the data of the corresponding group of pictures.

The foregoing video coding apparatus is configured to implement the video data coding method in the foregoing embodiment, the units included are classified based only on function logic, and the classification is not limited to the foregoing classification and is acceptable as long as corresponding functions can be implemented; additionally, specific names of functional units are only for easy differentiation from each other, but are not intended to limit the protection scope of the present invention.

FIG. 8 is a schematic structural diagram of a video data transmission apparatus provided by an embodiment of the present invention, the video data transmission apparatus may specifically be a base station, and as shown in the figure, the apparatus includes:

a video stream obtaining unit 801, configured to obtain a video stream through a network and send the obtained video stream to an indication information obtaining unit 802;

the indication information obtaining unit 802, configured to receive the video stream sent by the video stream obtaining unit 801, perform a deep packet inspection on the video stream, obtain data of a group of pictures and indication information corresponding to the data of the group of pictures, and send the obtained indication information to a priority obtaining unit 803;

the priority obtaining unit 803, configured to receive the indication information sent by the indication information obtaining unit 802, obtain a priority of each data frame in the data of the group of pictures in the indication information, and send the priority of each data frame to a data frame sending unit 804; and

the data frame sending unit 804, configured to receive the priority of each data frame sent by the priority obtaining unit 803, and send the data frame in the data of the group of pictures of the video stream according to an order of the priority.

The foregoing video data transmission coding apparatus is configured to implement the video data transmission method of the embodiment in FIG. 5, the units included are classified based only on function logic, and the classification is not limited to the foregoing classification and is acceptable as long as corresponding functions can be implemented; additionally, specific names of functional units are only for easy differentiation from each other, but are not intended to limit the protection scope of the present invention.

FIG. 9 is a schematic structural diagram of a video data transmission apparatus provided by an embodiment of the present invention, the apparatus may be a computer or a handheld terminal, and as shown in the figure, the terminal includes:

a receiving unit 901, configured to receive a video stream sent by the receiving unit, perform a deep inspection on the received video stream to obtain indication information, and send the indication information to an inspection unit 902;

the inspection unit 902, configured to perform a deep inspection on the received video stream, and obtain indication information;

an obtaining unit 903, configured to receive the indication information sent by the inspection unit 902, learn a data amount and a priority of each video data packet in the video stream based on the obtained indication information, and send the data amount and the priority of each video data packet to a request unit 904; and

the request unit 904, configured to receive the data amount and the priority of each video data packet sent by the obtaining unit 903, and send a resource request to a base station according to a current downlink channel resource and the size of the video data packet.

The foregoing video data transmission apparatus is configured to implement the video data transmission method of the embodiment in FIG. 6, the units included are classified based only on function logic, and the classification is not limited to the foregoing classification and is acceptable as long as corresponding functions can be implemented; additionally, specific names of functional units are only for easy differentiation from each other, but are not intended to limit the protection scope of the present invention.

Finally, it should be pointed out that, the present invention uses the video transmission data as an example, and provides a coding method that can reduce the inspection complexity; the embodiments of the present invention can also be applied in the audio data coding and transmission field, where persons skilled in the art should easily apply the coding method and the data transmission method provided by the present invention to the audio data transmission field; therefore, the audio data transmission adopting the method provided by the present invention shall also fall within the protection scope of the present invention.

Persons skilled in the art should be able to further realize that, in combination with the examples described in the embodiments disclosed in this specification, units and steps of the algorithm may be implemented by electronic hardware, computer software, or a combination thereof. In order to clearly describe the interchangeability between the hardware and the software, the foregoing has generally described compositions and steps of every embodiment according to functions. Whether the functions are executed by hardware or software depends on particular applications and design constraint conditions of the technical solutions. Persons skilled in the art may use different methods to implement the described functions for each particular application, but it should not be considered that the implementation goes beyond the scope of the present invention.

In combination with the embodiments disclosed in this specification, steps of the method or algorithm may be implemented by hardware, a software module executed by a processor, or a combination thereof. The software module can be placed in a random access memory (RAM), a memory, a read-only memory (ROM), an electrically programmable ROM, an electrically erasable programmable ROM, a register, a hard disk, a removable magnetic disk, a CD-ROM, or any storage medium of other forms well-known in the technical field.

The objectives, technical solutions, and beneficial effects of the present invention have been described in further detail through the above specific embodiments. It should be understood that the above descriptions are merely specific embodiments of the present invention, but not intended to limit the protection scope of the present invention. Any modification, equivalent replacement, or improvement made without departing from the spirit and principle of the present invention shall fall within the protection scope of the present invention.

What is claimed is:

1. A video data coding method, comprising:
obtaining video information;
coding the video information into a video stream, wherein the video stream comprises data of a group of pictures; and
setting indication information for the data of the group of pictures, and putting the indication information before the corresponding data of group of pictures, wherein the indication information is used to indicate a priority and a data amount of each data frame in the corresponding data of group of pictures.

2. The method according to claim 1, wherein the indication information comprises an indication information packet header, a field bit for indicating the priority of the data frame, and a field bit for indicating the data amount of the data frame.

3. The method according to claim 2, wherein the field bit for indicating the priority is a frame coding type field bit, a priority field bit, or a layered information field bit.

4. The method according to claim 1, wherein the indication information comprises the priority and data amount of each data frame in data of one corresponding group of pictures and a law of change of a priority and a data amount of each data frame in data of subsequent multiple groups of pictures.

5. The method according to claim 1, wherein after adding the indication information before data of each group of pictures among the data of the multiple group of pictures in the video stream, the method further comprises:
dividing the video stream, to which the indication information is added, into multiple IP packets.

6. A video data transmission method, comprising:
obtaining a video stream;
performing a deep packet inspection on the video stream, and obtaining data of a group of pictures and indication information corresponding to the data of the group of pictures;
obtaining a priority of each data frame in the data of the group of pictures from the indication information; and
sending the data frame in the data of the group of pictures of the video stream according to an order of the priority.

7. The video data transmission method according to claim 6, wherein after the obtaining a priority of each data frame in the data of the group of pictures from the indication information, the method further comprises:
obtaining a law of change of the priority and a size of each data frame in data of different groups of pictures from the indication information.

8. The method according to claim 6, wherein data of a single group of pictures among the data of the multiple groups of pictures further comprises multiple RTP packets, and each RTP packet further comprises multiple IP packets; and
after the obtaining the indication information and the data of the multiple groups of pictures, the method further comprises:
sorting the multiple IP packets again according to sequence numbers in packet headers of the RTP packets.

9. The method according to claim 6, wherein the sending the data frame in the data of the group of pictures of the video stream according to an order of the priority further comprises:
transmitting the IP packets based on the priorities in the indication information.

10. A video data transmission method, comprising:
receiving a video stream through a downlink channel;
performing a deep packet inspection on the received video stream and obtaining indication information;
learning a data amount and a priority of each video data packet in the video stream based on the obtained indication information; and
sending a resource request to a base station according to a current downlink channel resource and the data amount of the video data packet.

11. The method according to claim 10, wherein the sending a resource request to a base station further comprises:
requesting the base station to send the video data packet according to an order of the priority in the indication information.

12. A video coding apparatus comprising:
an obtaining unit, configured to obtain video information;
a coding unit, configured to code the obtained video information into a video stream, where the video stream includes data of multiple groups of pictures; and
an inserting unit, configured to set indication information for the data of the group of pictures, and put the indication information before the corresponding data of the group of pictures, where the indication information includes a priority and a data amount of each data frame in the corresponding data of the group of pictures.

13. A base station comprising:
a video stream obtaining unit, configured to obtain a video stream through a network;
an indication information obtaining unit, configured to perform a deep packet inspection on the video stream, and obtain data of a group of pictures and indication information corresponding to the data of the group of pictures;
a priority obtaining unit, configured to obtain a priority of each data frame in the data of the group of pictures from the indication information; and
a data frame sending unit, configured to send the data frame in the data of the group of pictures of the video stream according to an order of the priority.

14. A handheld terminal comprising:
a receiving unit, configured to receive a video stream through a downlink channel;
an inspection unit, configured to perform a deep inspection on the received video stream and obtain indication information;
an obtaining unit, configured to learn a size and a priority of each video data packet in the video stream based on the obtained indication information; and
a request unit, configured to send a resource request to a base station according to a current downlink channel resource and the size of the video data packet.
